(19) United States
(12) Patent Application Publication
(10) Pub. No.: US 2018/0165763 A1
(43) Pub. Date: Jun. 14, 2018

(54) SYSTEMS AND METHODS FOR AUTOMATICALLY STRUCTURING AND APPROVING OFFERS

(71) Applicant: Capital One Services, LLC., McLean, VA (US)

(72) Inventors: Nicholas Edmund DOLLE, McKinney, TX (US); John FULLER, Dallas, TX (US); Ray Stephen WEGER, Allen, TX (US); Meggin KAUFMAN, Dallas, TX (US); Caroline MCNALLY, New York, NY (US); Natalia LICHAGINA, Dallas, TX (US)

(73) Assignee: Capital One Services, LLC, McLean, VA (US)

(21) Appl. No.: 15/891,810

(22) Filed: Feb. 8, 2018

Related U.S. Application Data
(63) Continuation of application No. 14/871,511, filed on Sep. 30, 2015.
(60) Provisional application No. 62/152,501, filed on Apr. 24, 2015.

(51) Int. Cl. G06Q 40/02

(52) U.S. Cl. CPC G06Q 40/025

(57) ABSTRACT

A disclosed system for structuring and approving an offer may include one or more memory devices storing software instructions. The system may also include one or more processors configured to execute the software instructions to receive a loan application request, the loan application request including information identifying a vehicle characteristic. The one or more processors may be further configured to identify a vehicle that matches the vehicle characteristic and determine a loan offer for a customer to purchase the vehicle comprising at least a first loan term. The one or more processors may be further configured to provide the loan offer to an offer system, and receive a response from the offer system related to the loan offer, the response including a loan offer modification.

### PRIORITY CLAIM

This application claims priority under 35 U.S.C. § 119 to U.S. Provisional Application No. 62/152,501, filed on Apr. 24, 2015, and entitled “Systems and Methods for Automatically Structuring and Approving Offers,” which is expressly incorporated herein by reference in its entirety.

### TECHNICAL FIELD

The disclosed embodiments generally relate to systems and methods for evaluating offers, and more particularly, to systems and methods for automatically structuring and approving offers.

### BACKGROUND

Often when a customer seeks to purchase an expensive item, a purchase agreement between the customer and a merchant is contingent upon the customer being approved for credit financing, such as a loan from a bank. In some situations, such as car-buying, various terms of the agreement may be negotiated before it is known whether the agreement will be approved by the bank. For example, a customer and a merchant may agree to the sale of a vehicle in exchange for certain financial terms, such as monthly payment, down payment, length of loan, etc. The merchant may submit the potential agreement to the bank, which may make a determination regarding whether the offer is approved (based on, for example, whether the terms of the potential loan are justified by the credit risk associated with the customer from the bank's perspective). If the terms are approved, the merchant may officially extend the offer to the customer and, if accepted by the customer, complete the transaction.

If, however, the terms of a potential agreement are not approved by the bank, the merchant must negotiate new terms with the customer and then submit a new potential agreement. In one example, a merchant may submit an application for a customer to receive credit according to specific terms for the purchase of a specific item. If the application is denied, it is up to the merchant and the customer to reconfigure the terms and/or the item to be purchased and submit a new application, without knowing whether the changes will cause the new application to be approved. This laborious process may need to be repeated several times before the merchant and customer agree to terms approved by the bank.

Thus, using current systems, merchants, such as car dealerships, must balance customer preferences and potential credit restrictions when negotiating an offer that is acceptable to the merchant, without knowing whether the potential agreement will be accepted by the bank. This causes the process for structuring an agreement, to be time-consuming and inefficient. Thus, there is a need for a more efficient system for structuring and approving offers that include credit financing.

### SUMMARY

The disclosed embodiments include systems and methods that allow for automatic structuring and approval of offers, such as offers for the purchase or lease of a vehicle.

In one aspect, the present disclosure is directed to a system for structuring and approving an offer. The system may include one or more memory devices storing software instructions. The system may also include one or more processors configured to execute the software instructions to receive a loan application request, the loan application request including information identifying a vehicle characteristic. The one or more processors may be further configured to identify a vehicle that matches the vehicle characteristic and determine a loan offer for a customer to purchase the vehicle comprising at least a first loan term. The one or more processors may be further configured to provide the loan offer to an offer system, and receive a response from the offer system related to the loan offer, the response including a loan offer modification.

In another aspect, the present disclosure is directed to another system for structuring and providing an offer. The system may include one or more memory devices storing software instructions. The system may also include one or more processors configured to execute the software instructions to receive a loan application request, the loan application request including information identifying a customer. The one or more processors may be further configured to determine that the customer is provisionally approved for financing, and provide to an offer system a loan application response indicating that the customer is provisionally approved for financing. The one or more processors may be further configured to receive a loan offer modification from the offer system, the loan offer modification including a first loan term. The one or more processors may be additionally configured to determine a second loan term based on the first loan term, and provide to the offer system a loan offer for the customer to purchase a vehicle, the loan offer including the first loan term and the second loan term.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments;

FIG. 2 is a block diagram of an exemplary server, consistent with disclosed embodiments;

FIG. 3 is a flowchart of an exemplary loan application process, consistent with disclosed embodiments;

FIG. 4 is a flowchart of an exemplary loan offer process, consistent with disclosed embodiments;

FIG. 5 is a flowchart of an exemplary offer system interaction process, consistent with disclosed embodiments; and

FIGS. 6-9 are illustrations of exemplary user interfaces, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments include systems and methods for automatically structuring and approving offers for secured financing. For ease of discussion, embodiments may be described in connection with the sale of vehicles and auto loans commonly used to finance their purchase. It is to be understood, however, that disclosed embodiments are not limited to the sale of vehicles and may, in fact, be applied to the sale, auctioning, leasing, etc. of any item, product, or service. Indeed, the technical features associated with disclosed embodiments are not limited to application in any particular industry. Further, steps or processes disclosed herein are not limited to being performed in the order described, but may be performed in any order, and some steps may be omitted, consistent with the disclosed embodiments.

Consistent with disclosed embodiments, a system may quickly identify parameters/terms of potential financing offers associated with the sale of a vehicle that would be accepted by a financial service provider based on, for example, known information about the potential agreement (e.g., customer information, the vehicle or vehicles that the customer is interested in, identified financing terms, etc.). The system may provide a user interface through which a merchant and/or customer may provide information related to a potential agreement, and view agreement terms that would be accepted by the financial service provider. The user interface may further include options for the merchant and/or customer to quickly and easily adjust the terms to satisfy one or more preferences of the merchant and/or customer. In response, the system may automatically adjust certain other terms of the potential agreement to keep the potential agreement within acceptable limits for the financial service provider, and/or automatically provide an indication regarding whether the outlined terms represent an offer that would be accepted by the financial service provider. The functionality provided by the disclosed embodiments allow a car dealership to reduce the amount of time spent on reaching an agreement with a customer that is acceptable to all parties.

The features and other aspects and principles of the disclosed embodiments may be implemented in various environments. Such environments and related applications may be specifically constructed for performing the various processes and operations of the disclosed embodiments and may include one or more specialized apparatuses or systems configured to execute software programs that perform processes consistent with the disclosed embodiments. The apparatus(es) or system(s) may be specifically constructed with hardware and/or software components that provide the functionality and advantages of the disclosed embodiments.

The disclosed embodiments also relate to tangible and non-transitory computer readable media that include program instructions or program code that, when executed by one or more processors, perform one or more computer-implemented operations. The program instructions or program code may include specially designed and constructed instructions or code for achieving one or more aspects of the disclosed embodiments.

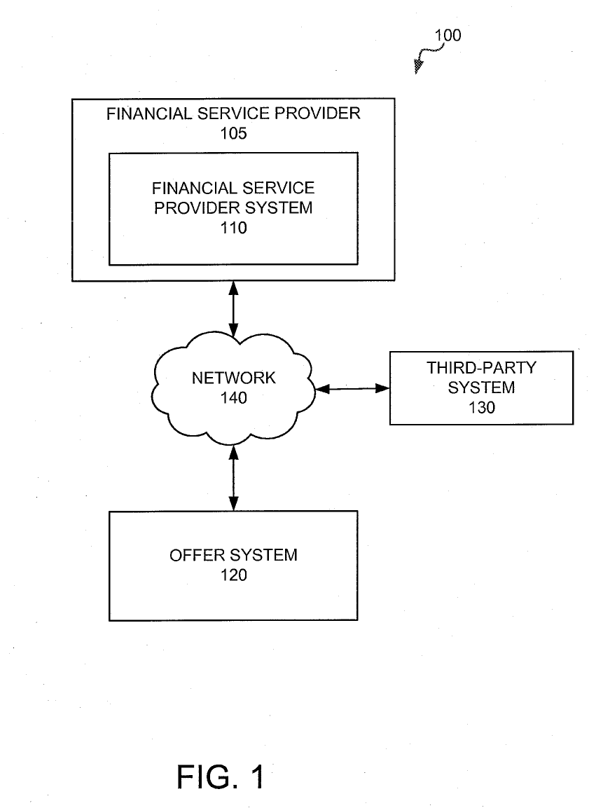

FIG. 1 shows an exemplary system 100 that may be configured to perform one or more software processes that, when executed, provide one or more aspects of the disclosed embodiments. The components and arrangement shown in FIG. 1 is not intended to be limiting to the disclosed embodiment as the components used to implement the processes and features disclosed here may vary.

In accordance with certain disclosed embodiments, system 100 may include a financial service provider 105, a financial service provider system 110, one or more offer devices 120, one or more third-party devices 130, and network 140. Other components known to one of ordinary skill in the art may be included in system 100 to process, transmit, provide, and/or receive information consistent with the disclosed embodiments.

Financial service provider 105 may be one or more entities that configure, offer, provide, and/or manage financial service accounts, such as credit card accounts, debit card accounts, checking or savings accounts, loyalty accounts, and/or loan accounts. In one aspect, financial service provider 105 may include or be associated with financial service system 110 that may be configured to perform one or more aspects of the disclosed embodiments. In some embodiments, financial service system 110 may configure one or more loan accounts for users (i.e., prospective buyers), such as a user operating offer system 120, using information pertaining to one or more additional financial service accounts provided by financial service provider 105 associated with financial service system 110.

Financial service system 110 may be one or more systems associated with one or more entities, such as financial service provider 105, that configures, offers, provides, and/or manages financial service accounts, such as credit card accounts, debit card accounts, checking or savings accounts, and loan accounts. Consistent with the disclosure, financial service system 110 may provide a loan account for financing a purchase of one or more users (i.e., prospective buyers). In some embodiments, the loan account may be an automotive vehicle loan account. In some embodiments, financial service system 110 may receive loan requests from users (via, i.e., offer system 120) relating to provided financial service accounts.

Financial service system 110 may be configured to provide a loan application tool that allows a merchant and/or customer to submit a loan application and enter into a loan agreement with financial service provider 105. For example, the loan application tool may allow financial service system 110 to assess the income, creditworthiness, risk, etc. associated with a prospective automobile buyer in real-time or substantially real-time, identify different financing offers based on those assessments, and provide those financing offers to offer system 120 (via, e.g., an API). In addition, the loan application tool may allow financial service system 110 to review a loan application and/or terms of a potential agreement between a customer and a merchant and provide financing offers that correspond to the potential agreement. For example, financial service system 110 may be configured to determine whether a loan application is approved and/or provide one or more alternative terms to those of the loan application, the alternative terms being part of an approved offer. Further, financial service system 110 may be configured to review terms of a potential agreement and supply other terms that would place the provided terms in an approved offer.

In some embodiments, financial service system 110 may store information associated with estimating vehicle values, depreciation trends, etc., as part of the loan application tool. For example, financial service system 110 may maintain a list of values associated with types of vehicles (e.g., based on make, model, year, condition, etc.) and/or may maintain an inventory of specific vehicles and an associated estimated value of those vehicles. For instance, financial service system 110 may store an inventory list associated with an auto dealership, the inventory list including a list of specific vehicles that the auto dealership possesses and an estimated value of the vehicle. The estimated value may include any value information (e.g., market value, residual value, etc.) which may be used by financial service system 110 to assess a loan application for the purchase of the associated vehicle.

Financial service system 110 may include one or more components that perform processes consistent with the disclosed embodiments. For example, financial service system 110 may include one or more computers (e.g., servers, database systems, etc.) configured to execute software instructions programmed to perform aspects of the disclosed embodiments, such as generating financial service accounts, maintaining accounts, processing financing requests and/or any other information relating to accounts, etc. Financial service system 110 may also be configured to execute stored software instructions to automatically structure and/or approve offers related to potential agreements between a customer and a merchant. Consistent with disclosed embodiments, financial service system 110 may include other components and infrastructure that enable it to perform operations, processes, and services consistent with disclosed embodiments. Consistent with disclosed embodiments, financial service system 110 may be configured to provide the loan application tool to offer system 120 or another component (shown or not shown) of system 100.

Offer system 120 may be one or more computer systems that are configured to perform computer-implemented processes. For example, offer system 120 may include a server, desktop computer, laptop, mobile device with computing ability (e.g., smart phone, tablet, etc.), or any combination of these computers and/or affiliated components. In an exemplary embodiment, offer system 120 may be associated with an auto dealership. For example, offer system 120 may be a computing device that is operated by an employee of the auto dealership to provide, assess, and/or modify financing options for a customer or prospective customer. In other embodiments, offer system 120 may be a computing device that is operated by the customer. For example, offer system 120 may be a personal computer or mobile device with computing ability associated with a customer or potential customer of an auto dealership (including any other person or entity selling a vehicle). Offer system 120 may be configured to communicate with financial service system 110 (e.g., via network 140) in order to access the loan application tool provided by financial service system 110.

Third-party device 130 may be one or more computer systems associated with a third-party. Third-party device 130 may include one or more computing systems that are configured to perform computer-implemented processes, such as a server, desktop computer, laptop, mobile device with computing ability, etc. In an exemplary embodiment, third-party device 130 may provide information and/or services related to a loan application and/or a potential purchase agreement. For example, third-party device 130 may be a credit-assessment entity that provides information related to the creditworthiness of a potential customer. In another example, third-party device 130 may be an inventory system that stores inventory information (e.g., vehicles in-stock at a dealership). In yet another example, third-party device 130 may be associated with a value estimation entity (e.g., Kelley Blue Book™, etc.) and configured to provide an estimated value of a specific vehicle or type of vehicle.

Network 140 may be any type of network that facilitates communications and data transfer between components of system 100, such as, for example, financial service system 110, offer system 120, and third-party system 130. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies that are familiar in the marketplace. Network 140 is not limited to the above examples and system 100 may implement any type of network that allows the entities (shown and not shown) included in FIG. 1 to exchange data and information.

Although FIG. 1 describes a certain number of entities and processing/computing components within system 100, any number or combination of components may be implemented without departing from the scope of the disclosed embodiments. For example, financial service system 110 may interact with users described as associated with offer system 120 through systems available to the users at brick-and-mortar locations, such as auto dealerships, such as computers provided by the brick-and-mortar to access the loan application tool provided by financial service system 110. Additionally, financial service system 110, offer system 120, and third-party device 130 are not mutually exclusive. For example, in one disclosed embodiment, financial service system 110 and offer system 120 may be the same entity or partnered with one another. The entities as described are not limited to their discrete descriptions above. Further, where different components of system 100 are combined (e.g., financial service system 110 and offer system 120, etc.), the computing and processing devices and software executed by these components may be integrated into a local or distributed system.

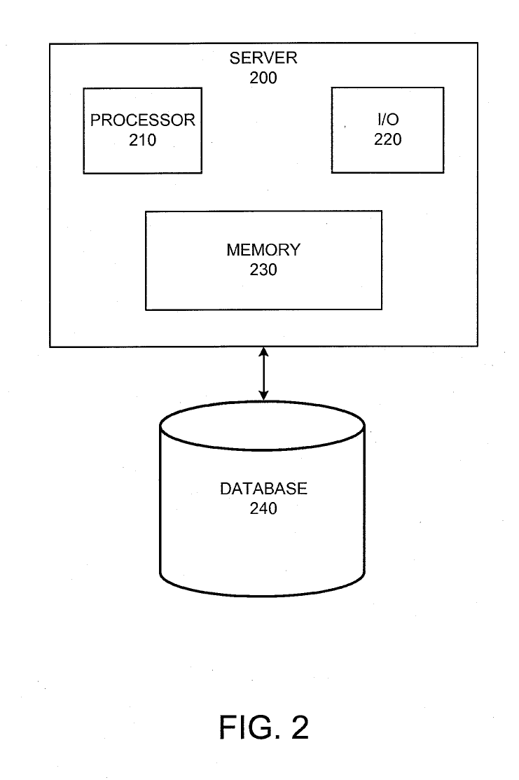

FIG. 2 depicts a server 200, consistent with disclosed embodiments. In an exemplary embodiment, financial service system 110 may include server 200. It should be understood, however, that although server 200 may be depicted and described herein as a component of financial service system 110 for ease of discussion, server 200 or variations thereof may be used alternatively or additionally by offer system 120, third-party device 130, and/or other components of system 100 (shown and not shown) to perform processes consistent with disclosed embodiments.

In one embodiment, server 200 may include one or more processors 210, one or more input/output (I/O) devices 220, and one or more memories 230. According to some embodiments, server 200 may comprise web server(s) or similar computing devices that generate, maintain, and provide web site(s) consistent with disclosed embodiments. Server 200 may be standalone, or it may be part of a subsystem, which may be part of a larger system. For example, server 200 may represent distributed servers that are remotely located and communicate over a network (e.g., network 140) or a dedicated network, such as a LAN.

Processor 210 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 200.

I/O devices 220 may be one or more devices configured to allow data to be received and/or transmitted by server 200. I/O devices 220 may include one or more user I/O devices and/or components, such as those associated with a keyboard, mouse, touchscreen, display, etc. I/O devices 220 may also include one or more digital and/or analog communication devices that allow server 200 to communicate with other machines and devices, such as other components of system 100. I/O devices 220 may also include interface hardware configured to receive input information and/or display or otherwise provide output information. For example, I/O devices 220 may include a monitor configured to display a user interface.

Memory 230 may include one or more storage devices configured to store instructions used by processor 210 to perform functions related to disclosed embodiments. For example, memory 230 may be configured with one or more software instructions associated with programs and/or data. Memory 230 may include a single program that performs the functions of the server 200, or multiple programs. Additionally, processor 210 may execute one or more programs located remotely from server 200. For example, financial service system 110, offer system 120, and/or third-party device 130, may, via server 200, access one or more remote programs that, when executed, perform functions related to disclosed embodiments. Memory 230 may also store data that may reflect any type of information in any format that the system may use to perform operations consistent with the disclosed embodiments.

Server 200 may also be communicatively connected to one or more database(s) 240. For example, server 200 may be communicatively connected to database(s) 240 through network 140. Database 240 may include one or more memory devices that store information and are accessed and/or managed through server 200. By way of example, database(s) 240 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 200 may include database 240. Alternatively, database 240 may be located remotely from the server 200. Database 240 may include computing components (e.g., database management system, database server, etc.) configured to receive and process requests for data stored in memory devices of database(s) 240 and to provide data from database 240.

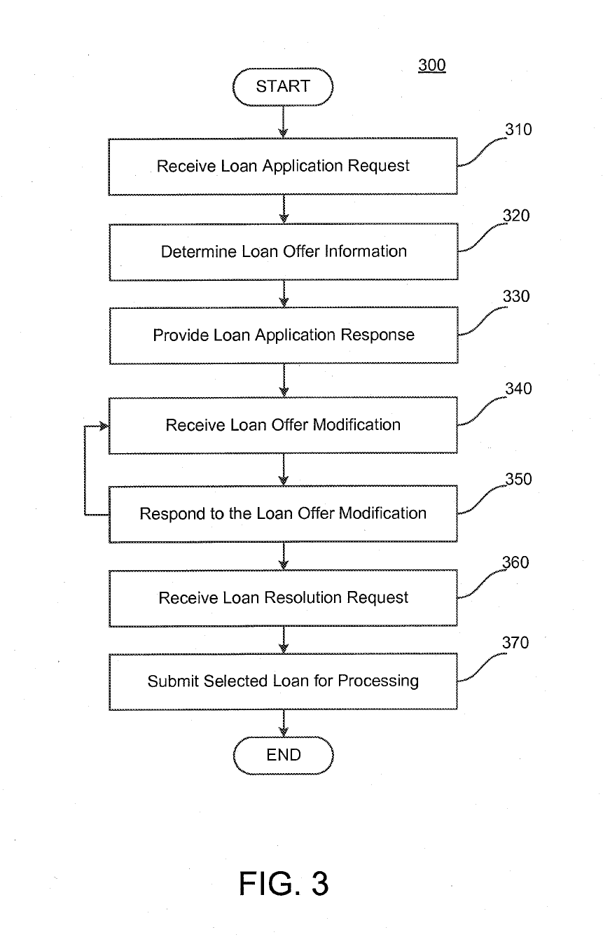

FIG. 3 is a flowchart of an exemplary loan application process 300, consistent with disclosed embodiments. In one embodiment, financial service system 110 may perform one or more of the steps of process 300 to provide a loan application tool to offer system 120. Through the loan application tool, financial service system 110 may automatically structure and approve potential loan agreements associated with the purchase of a vehicle. For example, one or more of the components of system 100 may execute instructions to perform one or more steps of process 300 to allow a user operating offer system 100 to quickly and easily determine approved loan agreements that satisfy the requirements and/or preferences of all parties involved.

In step 310, financial service system 110 may receive a loan application request. For example, offer system 120 may transmit a loan application request to financial service system 110. In some embodiments, the loan application request may include at least an indication that a user will operate the loan application tool provided by financial service system 110 to structure and identify one or more acceptable loan application terms. The loan application request may include any information that initiates the loan application process.

For example, the loan application request may include an auto loan application that includes customer and/or vehicle information. For example, financial service system 110 may receive information identifying a customer (e.g., name, address, social security number, driver's license number, etc.) from offer device 120. The auto loan application may also include information identifying one or more terms of the proposed loan. For example, the auto loan application may include the amount of the loan and the vehicle that will be purchased with the loan. Additional information may include the total price of the vehicle, down payment information, trade-in value, etc. In some embodiments, the auto loan application may include information identifying one or more vehicle characteristics (e.g., in addition to or instead of the exact vehicle that will be purchased). The one or more vehicle characteristics may identify the preferred characteristics of a vehicle that the customer would like to purchase. For example, the vehicle characteristics may include vehicle type, year, make, model mileage, sales price, days in inventory, and/or the like.

In some embodiments, a loan application request may include information sufficient for financial service system 110 to determine whether a customer is provisionally approved for financing. For example, the loan application request may include a customer identifying information (e.g., name, address, social security number, driver's license number, etc.). In some examples, the loan application request may also include information identifying the merchant (e.g., dealership) submitting the loan application request on behalf of the customer. A customer may be provisionally approved for financing if financial service system 110 determines that there are loan terms (e.g., parameters of the loan) that the financial service provider would approve for a loan to the customer.

In step 320, financial service system 110 may determine loan offer information. For example, financial service system 110 may use the received loan application and its contents to determine whether to approve the loan application, and, if the loan application is approved, the terms of the loan. For example, financial service system 110 may determine, based on information concerning the vehicle to be purchased, the requested loan amount, and customer information that the loan application is approved for a particular amount, repayment period, interest rate, etc. In some examples, financial service system 110 may determine terms for a plurality of approved potential loans, such as loans of varying length, down payment amounts, interest rates, etc. In some embodiments, financial service system 110 may determine that the customer is provisionally approved for a loan and wait for further information before determining terms of the loan.

In an exemplary embodiment, financial service system 110 may use a credit policy and pricing program to determine whether the loan application is approved. In some embodiments, financial service system 110 may also use the credit policy and pricing program to determine a range of terms that would be part of an approved loan associated with a received loan application request. For example, in instances where vehicle characteristics are provided instead of a particular vehicle in the auto dealer's inventory, financial service system 110 may identify one or more approved potential loans for one or more vehicles that match the desired vehicle characteristics.

In some instances, financial service system 110 may determine that a loan that matches the parameters of the loan application cannot be approved. For example, the customer may not be approved for the requested loan amount under the terms submitted in the application. In this instance, financial service system 110 may determine that the requested loan is denied, but may determine one or more similar loan offers that would be approved. For example, financial service system 110 may determine terms of a loan offer that would be approved and that matches at least one of the terms of the requested loan or is otherwise similar thereto (e.g., a lower loan amount at a shorter loan term period than requested).

In step 330, financial service system 110 may provide a loan application response to offer system 120. For example, financial service system 110 may provide an indication that the loan application is approved, and may also provide approved terms of the loan offer. For example, financial service system 110 may provide the loan interest rate that is associated with the approved loan. In some embodiments, financial service system 110 may also provide terms associated with one or more other approved loan offers. These other approved loan offers may be similar to the requested loan, but may include one or more different terms or parameters. For example, financial service system 110 may determine that the customer would also be approved for a lower interest rate if the loan amount were reduced and identify the terms associated with such a corresponding loan offer. In another example, financial service system 110 may access an inventory listing of vehicles for an auto dealership associated with the original loan application request and identify one or more other vehicles that the customer could purchase with the approved loan. The approved loan for the identified other vehicles may include corresponding different terms than the requested loan, providing the customer with additional vehicle purchase options. In some instances, financial service system 110 may provide only an indication that the customer is provisionally approved for financing.

In an exemplary embodiment, financial service system 110 may provide a user interface that allows a user to further utilize the loan application tool provided by financial service system 110. For example, financial service system 110 may provide a user interface that allows a user to modify the structure of an approved loan and/or provide additional information for financial service system 110 to determine the structure of an approved loan. For example, the user interface may include interactive fields, menus, lists, etc. that allow a user to change one or more terms of the loan. For instance, a user may modify and/or add a down payment amount, loan term period (e.g., number of monthly payments), sales price, warranty and/or GAP amount, net trade-in value, and/or the like. In another example, a user may modify the vehicle or vehicle characteristics for which a loan is sought.

In step 340, financial service system 110 may receive a loan offer modification from offer system 120. For example, offer system 120 may send a modified loan request. The modified loan request may include one or more terms that were not included in the loan application request provided in step 310 or the loan application response provided in step 330. For instance, the modified loan request may include terms that were modified by the user using the user interface provided by financial service system 110 and/or new terms that were not previously provided to financial service system 110.

In step 350, financial service system 110 may provide a response to the loan offer modification received in step 360. For example, financial service system 110 may determine whether the modified loan application is approved and send a response indicating the determination (e.g., loan approved or denied). In addition, financial service system 110 may determine that the loan modification request can be accommodated if one or more other terms are adjusted. The response to the loan offer modification may then include one or more modified loan offers that include the requested term and the modified other terms. In some embodiments, financial service system 110 may provide a response substantially in real-time.

Steps 350 and 360 may be repeated, as necessary, to allow a user to interact with financial service system 110 and the loan application tool provided by financial service system 110. For example, a user may provide a new or modified loan term to offer system 120 (e.g., via an I/O device), which may provide the request to financial service system 110. Financial service system 110 may determine one or more approved potential loans that correspond to the new or modified loan term and provide the approved potential loans back to offer system 120, which may be displayed and again modified by the user to repeat the cycle. In this way, a user may sort through approved potential loans until a loan that satisfies the preferences of the customer and the requirements of the merchant is found.

In some embodiments, financial service system 110 and/or offer system 120 may save approved potential loans as approved loan scenarios. For example, a user may provide input to offer system 120 to save an approved potential loan as an approved loan scenario. The user may then operate offer system 120 and/or financial service system 110 to repeat one or more steps of process 300 to produce one or more additional approved loan offers (e.g., loans offers for a different vehicle). Financial service system 110 and/or offer system 120 may also save the additional approved loan offers as approved loan scenarios. Financial service system 110 and/or offer system 120 may provide a user interface that includes multiple saved approved loan scenarios when requested. In this way, a user can use the loan application tool provided by financial service system 110 to produce a plurality of possible loan scenarios that are approved by financial service provider 105, thus allowing the user to select amongst several options.

In step 360, financial service system 110 may receive a loan resolution request. For example, a user may select an approved loan offer or saved approved loan scenario that corresponds to an agreement between a customer and the merchant to purchase a vehicle. Offer system 120 may provide the selection to financial service system 110 with the agreement information (or with an indication that the agreement was reached), and indicate to financial service system 110 that the loan should be processed. In another example, offer system 120 may send a notification to financial service system 110 indicating that agreement could not be reached and that the process should end.

In step 370, financial service system 110 may submit the selected loan to a loan processing system. (which may be, e.g., another component of financial service system 110) to process the loan to allow the purchase to be completed. In some embodiments, financial service system 110 may submit the selected loan through an existing loan processing channel to third-party device 130 for processing of the loan.

Financial service system 100 may perform one or more steps of process 300 to provide a loan application tool to offer system 120, which may be utilized by a user to quickly and efficiently reach a purchase agreement that is accepted by both the customer and the merchant. For example, an employee of an auto dealership (e.g., a salesperson) may operate offer system 120 to use the loan application tool to sort through a plurality of potential loans that are approved by financial service provider 105, allowing the employee to provide a customer with a detailed account of the options that are available.

The loan application tool provided by financial service system 110 automatically structures loans around provided information such that the employee can review one or more deal frameworks and adjust the deal structure(s) as decisions and agreements are made by and between the customer and merchant. Once an agreement within the framework is reached, the process can quickly move along, because the loan application tool provides potential deals that are already approved by financial service provider 105. This avoids an iterative process required by existing technology where the merchant and customer must wait to receive a notification regarding whether the loan is approved or denied. The loan application tool provided by financial service system 110 may also provide additional functionality through consideration of an actual inventory of a merchant (e.g., an auto dealership), as detailed in the exemplary process described below.

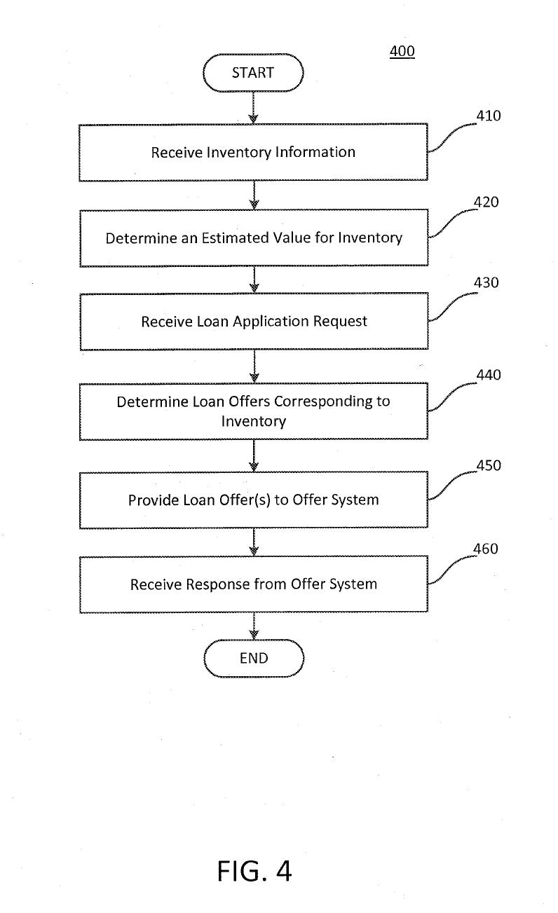

FIG. 4 is a flowchart of an exemplary loan offer process 400, consistent with disclosed embodiments. In some embodiments, financial service system 110 may perform one or more of the steps of process 400 to determine potential loan offers that are approved by financial service provider 105 and correspond to terms provided by a user operating, e.g., offer system 120.

In certain aspects, process 400 may allow financial service system 110 to structure the framework of a loan offer around information that is provided by a user (via, e.g., offer system 120) and inventory information associated with a merchant. In this way, exemplary process 400 may allow a user to provide some information related to a desired loan, and for financial service system 110 to provide one or more complete loan options that satisfy at least some of the terms of the request based on inventory information. The user can then operate offer system 120 to select from a plurality of loan options and base an agreement on that deal structure, instead of requiring that the agreement be in place for a particular vehicle before the loan application request is even made.

In step 410, financial service system 110 may receive inventory information related to a merchant. For example, financial service system 110 may receive a list of vehicles for sale at an auto dealership from, e.g., third-party system 130. The list of vehicles may include general information describing each vehicle and its characteristics (e.g., vehicle type, year, make, model mileage, sales price, days in inventory, and/or the like) and may also include specific information related to each vehicle (e.g., Vehicle Identification Number (VIN)). Financial service system 110 may store information related to each vehicle in association with an identifier of the entity (e.g., auto dealership) holding the vehicle for sale. Financial service system 110 may store inventory information associated with a plurality of dealerships.

In step 420, financial service system 110 may determine an estimated value of each vehicle in the inventory list(s). For example, financial service system 110 may consult third-party device 130, which may be an entity that values vehicles (e.g., Kelley Blue Book™, NADA Guides™, etc.). Financial service system 110 may store the estimated value in conjunction with the vehicle in the vehicle inventory list. In this way, financial service system 110 may quickly and easily retrieve a vehicle's estimated value (e.g., for use in determining terms of an approved potential loan). In other embodiments, financial service system 110 may consult third-party device 130 for the estimated value of specific vehicles in an inventory list in response to receiving a loan application request (step 430, below) that involves those specific vehicles.

In step 430, financial service system 110 may receive a loan application request. For example, financial service system 110 may receive a loan application request from offer system 120, as described above with respect to process 300. The loan application request may include information identifying a customer and/or a vehicle that the customer is considering purchasing. In one example, the information identifying the vehicle may include information that identifies the exact vehicle that the customer is considering for purchase (e.g., VIN). In another example, the information identifying the vehicle may include only characteristics of a vehicle (e.g., vehicle type, year, make, model mileage, sales price, days in inventory, and/or the like). In still another example, the loan application may only identify the customer (thus allowing the financial service provider to access, for example, financial information associated with the customer) with no particular vehicle or vehicle type indicated.

In step 440, financial service system 110 may also determine one or more loan offers in response to the loan application request, each loan offer corresponding to a specific vehicle or set of vehicles in an inventory list stored by financial service system 110 or accessed from, e.g., a third-party system 130 associated with the underlying auto dealer. The one or more loan offers may depend on whether an exact vehicle or type of vehicle that the customer is considering to purchase is identified, or whether only characteristics describing a desired vehicle are provided.

If the loan application request includes information identifying a specific vehicle that the customer is considering purchasing, the one or more loan offers may include at least one loan offer that is directed to the purchase of that vehicle when the customer is approved for a loan for that vehicle. The loan offer may include approved terms for the loan, which financial service system may determine based on the customer's identity (e.g., credit background, risk assessment, etc.) and the estimated value, expected depreciation over the term of the approved loan, etc. for the vehicle.

In some instances, the financial service system 110 may additionally or alternatively provide a loan offer directed to the purchase of a vehicle that Was not identified in the loan application request, such as a comparable vehicle that is also in the inventory list associated with the corresponding dealership or a vehicle that matches desired characteristics provided with the loan application request. For example, if the customer is not approved for a loan to purchase the desired vehicle, financial service system 110 may identify a vehicle for which a loan request is approved. But even if the customer is approved for the desired vehicle, financial service system may determine a loan offer for another vehicle, thereby providing a user with multiple options for a possible agreement. The loan offer associated with this other vehicle may also include approved loan terms determined by financial service system 110.

If the loan application request includes characteristics of a desired vehicle (with or without the identification of a specific vehicle), financial service system 110 may identify a plurality of vehicles that satisfy the characteristics. For example, financial service system 110 may search a vehicle inventory list associated with a corresponding auto dealership to identify vehicles that satisfy the characteristics provided with the loan application request. Financial service system 110 may determine one or more loan offers that correspond to one or more of the matching vehicles, including approved loan terms based on the customer information and the estimated values of the identified vehicles.

In step 450, financial service system 110 may provide the one or more loan offers to offer system 120. For example, financial service system 110 may transmit a list of approved loan offers and terms and user interface information for configuring offer system 120 to display the approved loan offers and terms. In one embodiment, the loan offer may be displayed in detail by offer system 120. The loan offer may include any relevant information to the offer, including the terms of the offer, as well information that identifies the process by which the loan offer was generated. For example, the loan offer may include loan amount, loan term period, interest rate, payment amount, and the like. The loan offer may also include information such as the estimated value of the vehicle used to determine the loan offer.

In step 460, financial service system 110 may receive a response from offer system 120. For example, financial service system 110 may receive a request to store one or more of the loan offers. The selected loan offer(s) may be stored and recalled upon request (e.g., by the user accessing a shopping cart style interface displayed on offer system 120) to allow the user to further refine the options that are available for agreement.

In another example, financial service system 110 may receive a loan offer modification, which may include a request that one or more aspects of the loan offer be modified, as describe above with respect to steps 340 and 350 of process 300. The loan offer modification may include a request to modify one or more terms of the loan offer, a request for that the loan offer become associated with a different vehicle, a request to update/contest the estimated value of the vehicle used to determine the loan offer, and/or the like.

In yet another example, financial service system 110 may receive an acceptance of a loan offer. The acceptance of the loan offer may indicate which loan offer (if there are multiple) was accepted. Financial service system 110 may proceed to submit the accepted loan offer for processing to complete the loan process.

Process 400 may allow a user, such as an employee of an auto dealership, to quickly and easily sort through loan offers and deal structures for specific vehicles that are for sale by the auto dealership that are approved for a particular customer. In particular, because financial service system 110 has access to an inventory list of vehicles for sale at the auto dealership (e.g., stored by a third-party system 130 associated with the auto dealership), and has an estimated value stored (or otherwise available for generation on command) for each vehicle in the list, financial service system 110 may be able to provide a variety of financing options for a customer. The user may operate offer system 120 to cause financial service system 110 to perform one or more steps of processes 300 and/or 400, as described in more detail below.

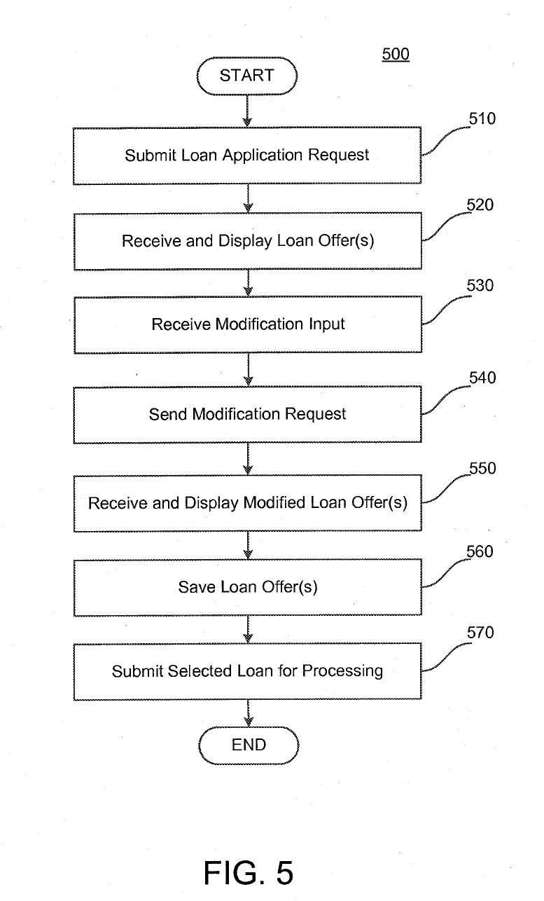

FIG. 5 is a flowchart of an exemplary offer system interaction process 500, consistent with disclosed embodiments. In some embodiments, offer system 120 may perform one or more steps of process 500 to utilize the loan application tool provided by financial service system 110. In one embodiment, offer system 120 may be a dealership system (e.g., computer) that accesses the loan application tool through network 140 (e.g., through a website, web app, API, or the like).

In step 510, offer system 120 may submit a loan application request. For example, offer system 120 may provide a user interface that allows a user to enter information related to a loan application. For example, offer system 120 may receive customer information, loan information, vehicle information, etc. Offer system 120 may send the received information to financial service system 110 to initiate a loan application process (e.g., process 300). In some embodiments, offer system 120 may submit a loan application request through an existing loan application channel. Financial service system 110 may receive the loan application request and determine one or more loan offers in response to the request.

In some embodiments, financial service system 110 may first determine that the customer is provisionally approved for financing and send the determination to offer system 120. Offer system 120 may then send one or more loan terms to financial service system 110 (which may constitute a loan offer modification, as used herein), which financial service system 110 may use to determine the one or more loan offers.

In step 520, offer system 120 may receive and display the loan offers determined by financial service system 110. For example, offer system 120 may receive information from financial service system 110, including information for providing a user interface that lists one or more loan offers that correspond to the loan application request. The loan offers may include, for example, a loan offer that includes all of the terms of the loan application request, if approved, and any additional terms (e.g., interest rate, loan term period, etc.), that may have been determined by financial service system 110. Additionally or alternatively, offer system 120 may receive one or more offers that include at least one term that is different from a corresponding term of the loan application request, such as to provide the user with additional options that may be considered.

In step 530, offer system 120 may receive a loan offer modification. For example, offer system 120 may provide a user interface that allows a user to modify one or more terms of an approved loan offer (e.g., change the loan amount, loan term period, vehicle, etc.). The user may operate offer system 120 to input one or more terms that differ from one of the approved terms using an input device (e.g., mouse, keyboard, touchscreen, etc.). Offer system 120 may receive the modification and display it through the user interface.

In step 540, offer system 120 may send a loan offer modification request to financial service system 110. For example, offer system 110 may send at least the requested term to be modified to financial service system 110. Financial service system 110 may receive the loan offer modification and determine whether to approve a loan offer that includes the requested different term. Financial service system 110 may respond to offer system 120 by providing a loan offer that includes a term similar to the requested different term or by providing a loan offer that includes the requested different term but modifies other terms associated with the original loan offer.

In step 550, offer system 120 may receive and display one or more modified loan offers received from financial service system 110. For example, offer system 120 may receive a modified loan offer from financial service system 110 along with information for providing a user interface that provides the details of the modified loan offer (e.g., the terms that are modified from the previous loan offer).

In step 560, offer system 120 may save one or more loan offers. For example, offer system 120 may save a loan offer locally to a memory device. In other embodiments, offer system 120 may transmit a request to financial service system 110 to save one or more loan offers. The saved loan offers may be stored as part of a user profile for retrieval at a later time. In some embodiments, offer system may receive a request to print one or more loan offers (e.g., for a merchant to provide to a customer). Saved loan offers may be retained for a selected amount of time (e.g., as long as the loan offer is valid).

In step 570, offer system 120 may submit a selected loan for processing. For example, offer system 120 may first receive a selection of a loan offer. The selected loan offer may correspond to an agreement between a merchant and a customer. Offer system 120 may send a notification to financial service system 110 identifying the selected loan offer and indicating that the loan offer is accepted and should be processed.

Process 500 may allow a user to interact with the loan application tool provided by financial service system 110, through user interfaces provided by offer system 120. In one example, a user (e.g., an employee of an auto dealership) may fill out a loan application using offer system 120, which may include a vehicle that a customer is considering purchasing and information identifying the customer. Offer system 120 may send the loan application to financial service system 110, which may determine that the customer is approved for the requested loan, at a particular interest rate. Offer system 120 may receive the loan offer, which may be displayed and presented to a customer. The customer may determine that the interest rate is too high and provide a modified loan application request to offer system 120 that includes a higher down payment and lower loan amount as different terms from the original loan application. Offer system 120 may send the modified loan request to financial service system 110, which may determine that the customer is approved for a modified loan that includes a lower interest rate. Offer system 120 may receive the modified loan offer, which may be displayed and presented to the customer. The customer may decide to accept the modified loan offer, and the user may provide input to offer system 120 to select the modified offer and send the selection to financial service system 110 for processing.

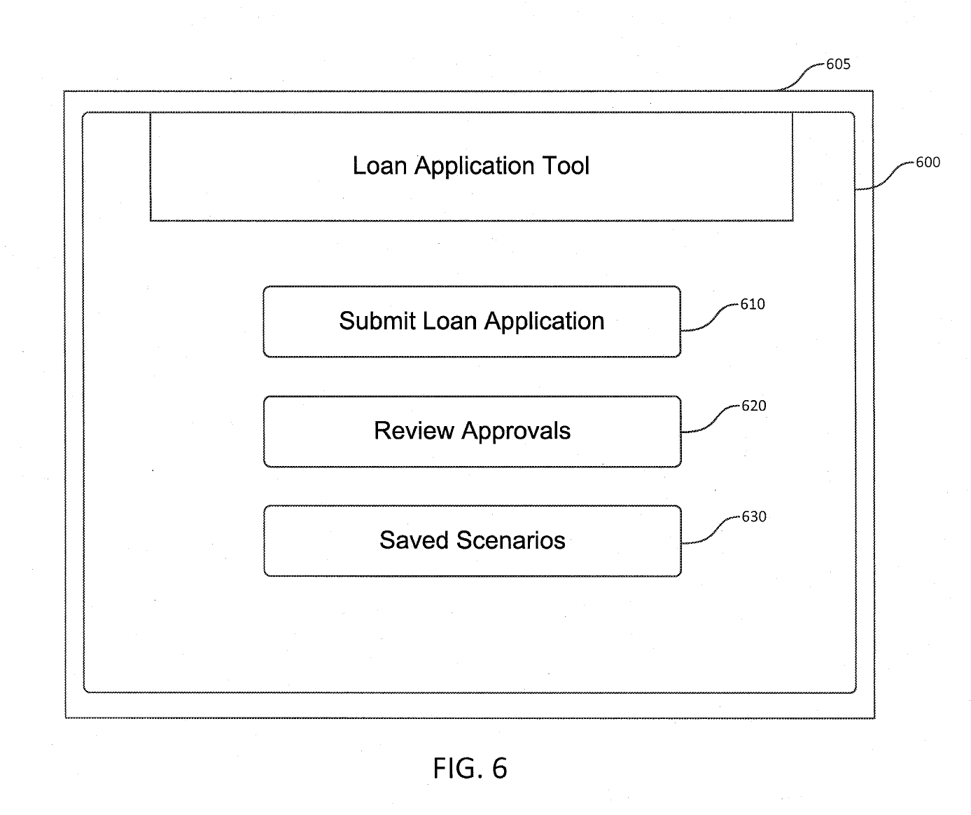

FIGS. 6-9 include exemplary user interfaces that may be provided by offer system 120 in association with a loan application tool 600 provided by financial service system 110. For example, offer system 120 may display the exemplary user interfaces based on input information (e.g., from a user) and information received from financial service system 110 (and/or third-party device 130), as well as on information stored by offer system 120 to provide loan application tool 600. In one example, loan application tool 600 may be provided through a website, web app, browser plugin or the like accessed by offer system 120. In other examples, loan application tool 600 may comprise a program installed on offer system 120 that locally generates the disclosed user interfaces and receives and/or accesses (via, e.g., network 140) the information for display from financial service provider system 110 and/or third-party system 130 via, for example, one or more APIs. It should be understood that the user interfaces are exemplary and that other configurations, including different or additional functionality, options, links, settings, etc. consistent with disclosed embodiments are possible.

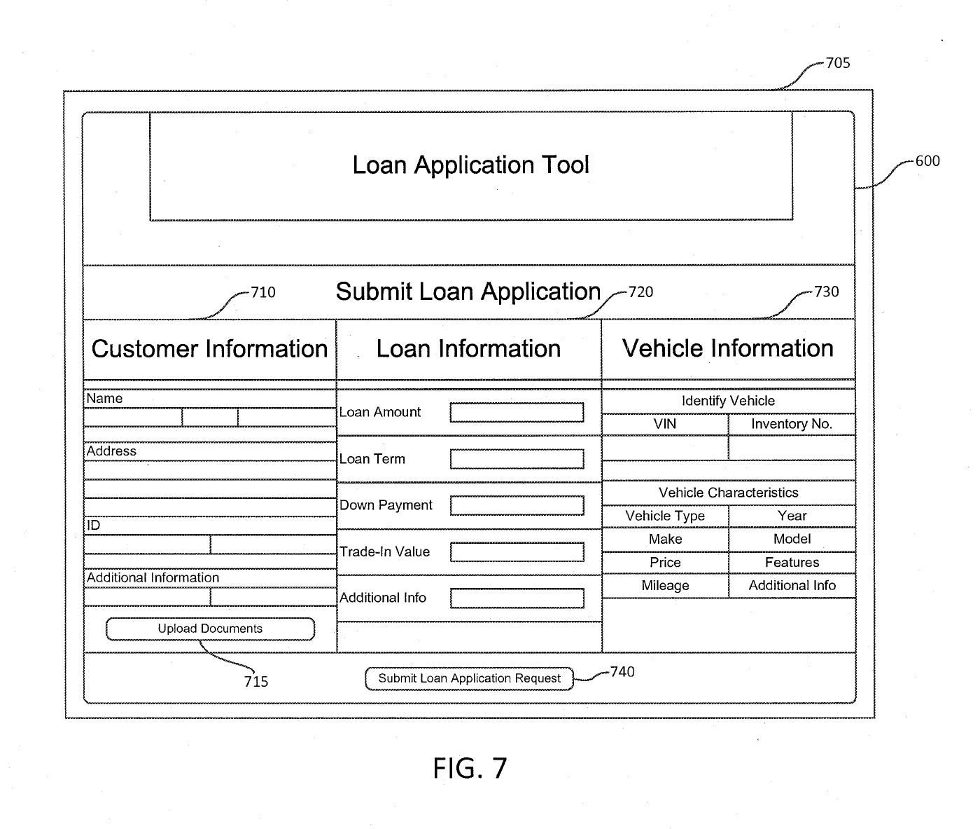

FIG. 6 is an exemplary user interface 605 that includes a menu page associated with loan application tool 600, consistent with disclosed embodiments. For example, user interface 605 may include one or more options that a user may select to access to a certain feature of loan application tool 600. In one example, user interface 605 may include an application submission option 610, an approval review option 620, and a saved scenarios option 630. These options will be described in more detail with respect to FIGS. 7-9 below. It should be understood that these options are exemplary and that loan application tool 600 may include additional or alternative options.

FIG. 7 is an exemplary user interface 705 associated with submission option 610. For example, a user may select application submission option 610, which may cause offer system 120 to display user interface 705. User interlace 705 depicts an exemplary user interface for receiving information related to a loan application. For example, user interface 705 may include interactive fields that allow a user to input information for use in applying for a loan.

In one embodiment, user interface 705 may include customer information 710, loan information 720, and vehicle information 730. Customer information 710 may include a plurality of fields which allow a user to enter customer identifying information (e.g., name, social security number, financial account credentials, etc.). In some embodiments, customer information 710 may include an option 715 for uploading a document, such as a copy of a driver's license, proof of address, proof of insurance, trade-in estimate, etc. Loan information 720 may include a plurality of fields which allow a user to enter information identifying loan terms and/or loan preferences. For example, loan information may include fields for receiving the entry of information regarding a loan amount, loan term period, down payment, etc. Vehicle information 730 may include a plurality of options fields for receiving the entry of information associated with a vehicle that the customer is considering purchase. For example, vehicle information 730 may include options for receiving a selection of information identifying a particular car that the user is considering (e.g., VIN, inventory number, etc.). Vehicle information 730 may also additionally or alternatively include other options for receiving the entry of information from a user regarding characteristics of a desired vehicle.

User interface 705 may further include a submission button 740. Upon detecting user-selection of submission button 740, offer system 120 may send the entered information associated with a loan application to financial service system 110. Financial service system 110 may receive the loan application and determine one or more loan offers in response.

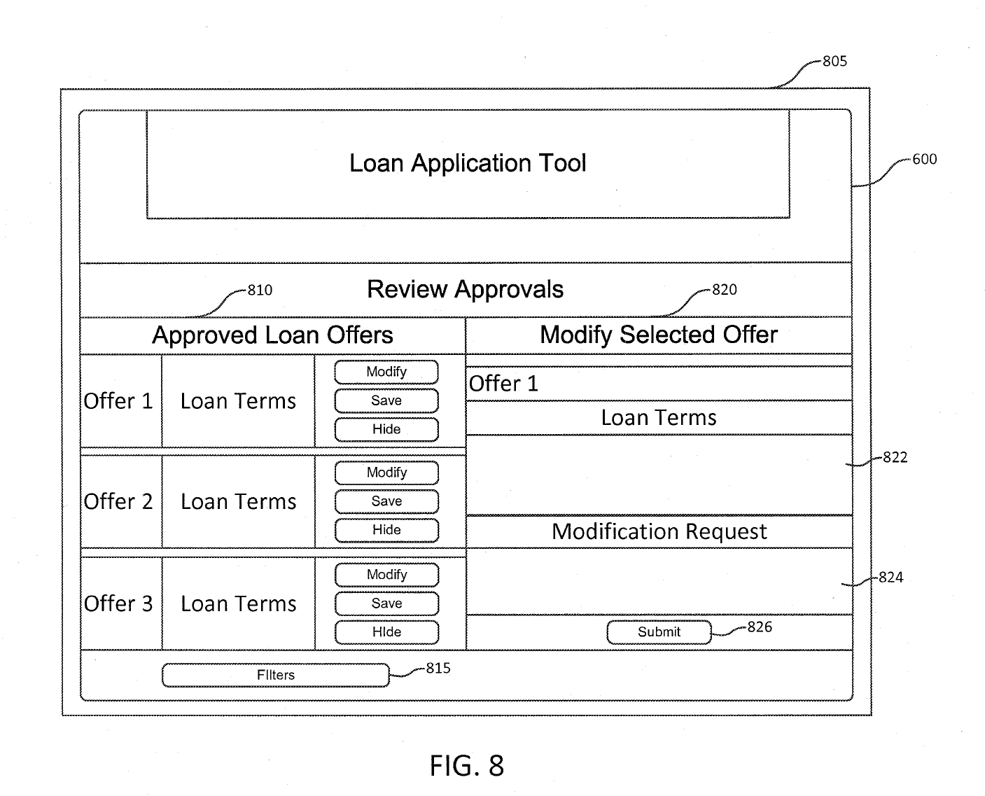

FIG. 8 is an exemplary user interface 805 associated with approval review option 620. In one example, offer system 120, via user interface 805, may display one or more loan offers that were determined based on a loan application request. For example, user interface may include approved loan offers 810. The approved loan offers may include at least a preview of the loan terms associated with the loan offer, as well as options for the user to modify, save, or hide the loan offer. User interface 805 may further include filter options 815 allowing further narrowing of the loan offer options according received user's preferences (associated user interface for receiving filter option selections not shown). In this way, a user can sort through loan offers that correspond to a submitted loan application and determine whether one or more of the loan offers may serve as the basis for an agreement between a merchant and customer.

User interface 805 may further include options to modify an approved loan offer 810. For example, user interface 805 may include a selected loan offer 820 display area, along with a loan terms 822 display area detailing the associated loan terms. User interface 805 may further include a modification request option 824 which allows a user to enter different terms for the corresponding loan offer. User interface 805 may further include an option 826 for the user to submit a modified loan request. Financial service system 220 may receive the modified loan request and provide a response, which may include one or more modified loan offers.

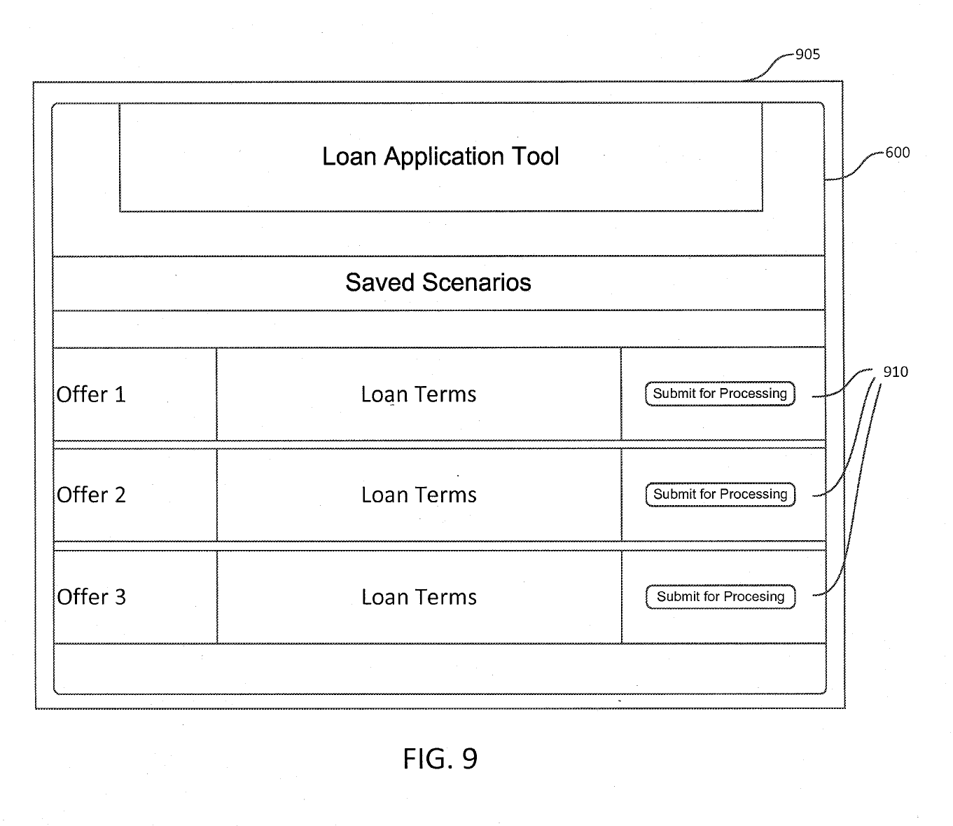

FIG. 9 is an exemplary user interface 905 associated with saved scenarios option 630. For example, offer system 120 may display user interface 905 to provide a listing of loan offers 910 that were previously saved (e.g., by a user). In this way, the user can review loan offers that were selected as potential options for the customer in one location. For example, user interface 905 may provide the saved scenarios in a shopping cart style that allows the user to quickly and easily review the available options. User interface 905 may further include options for the user to select one or more of the loan offers 910 for processing, once a corresponding agreement is reached.

The disclosed embodiments provide a user with an efficient tool for quickly and easily viewing loan options available to a customer. The loan application tool may be used to structure a loan offer or framework for an offer that would be approved if the merchant (e.g., auto dealership) and customer come to an agreement for a product or service (e.g., a vehicle), allowing a customer to consider loan options during the purchase selection process. Further, the availability of inventory information and estimated vehicle values allows for quick loan offer decisions. This further allows the loan application tool to provide many loan offers for different vehicles simultaneously in real-time or substantially real-time. These and the other features described herein provide a comprehensive and efficient tool that avoids the drawbacks of existing systems whose configuration requires the use of a drawn-out, iterative process for identifying loan offers.

As discussed above, it should be understood that the disclosed embodiments may be applied to different types of sales. Any financial service institution that provides loan accounts to customers may employ systems, methods, and articles of manufacture consistent with certain principles related to the disclosed embodiments. In addition, any buyer or seller of any automotive vehicle may also employ systems, methods, and articles of manufacture consistent with certain disclosed embodiments

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

1-17. (canceled)

18. A system for providing a loan offer, the system comprising:
at least one memory device storing software instructions; and
at least one processor configured to execute the software instructions to perform operations comprising:
receiving, from a remote device, a loan application request, the loan application request comprising a loan term, an identification of a desired vehicle having set of vehicle characteristics, and information identifying a customer;
determining that the customer is not provisionally approved for financing of the desired vehicle;
providing, to the remote device, a loan application response indicating that the customer is not provisionally approved for financing of the desired vehicle;
accessing a merchant inventory database of vehicles available for sale at a merchant location, the database comprising vehicle characteristics for the available vehicles;
obtaining estimated values of the available vehicles from a third party evaluation source;
determining, based on a set of mathematical rules relating to the desired vehicle characteristics, the available vehicle characteristics, the estimated values, and the customer information, that the customer is pre-approved for financing for purchase of a selected one of the available vehicles; and
providing, to the remote device, a loan offer indicating that the customer is approved for financing to purchase the selected available vehicle.

19. The system of claim 18, wherein the information identifying the customer includes at least one of: a name, an address, a social security number, or a driver's license number.

20. The system of claim 18, wherein the vehicle characteristics includes at least one of: a vehicle identification number (VIN), an inventory number, a vehicle type, a year, a make, a model, a mileage, a sales price, or a number of days in inventory.

21. The system of claim 18, wherein determining the customer is not provisionally approved for financing comprises monitoring a financial account of the customer.

22. The system of claim 18, wherein the loan term comprises at least one of: a requested loan amount, a repayment period, an interest rate, or a down payment amount.

23. The system of claim 18, wherein determining the customer is not provisionally approved for financing comprises an analysis of a customer credit report.

24. The system of claim 23, wherein the analysis of the customer credit report includes determining whether a customer credit score is less than a predetermined threshold value.

25. The system of claim 18, wherein the operations further comprise transmitting the vehicle characteristics for the available vehicles to the third party evaluation source for determining estimated values.

26. The system of claim 25, wherein the operations further comprise storing the estimated values for the available vehicles.

27. The system of claim 26, wherein the estimated value of the selected available vehicle is less than a vehicle value of the desired vehicle.

28. The system of claim 18, wherein the operations further comprise receiving a second loan application request, wherein the second loan application request includes a modification of the loan offer.

29. The system of claim 28, wherein the modification of the loan offer includes a change or input of at least one of: a down payment amount, a loan term period, a sales price, or a trade-in value.

30. The system of claim 28, wherein the operations further comprise providing, to the customer device, an indication that the customer is approved for financing based on loan offer modification.

31. The system of claim 18, wherein the operations further comprise transmitting instructions for executing a loan agreement, based on receiving an indication that the customer accepted the provided loan offer.

32. A method for providing a loan offer, the method comprising:
receiving, from a remote device, a loan application request, the loan application request comprising a loan term, an identification of a desired vehicle having set of vehicle characteristics, and information identifying a customer;
determining that the customer is not provisionally approved for financing of the desired vehicle;
providing, to the remote device, a loan application response indicating that the customer is not provisionally approved for financing of the desired vehicle;
accessing a merchant inventory database of vehicles available for sale at a merchant location, the database comprising vehicle characteristics for the available vehicles;
obtaining estimated values of the available vehicles from a third party evaluation source;
determining, based on a set of mathematical rules relating to the desired vehicle characteristics, the available vehicle characteristics, the estimated values, and the customer information, that the customer is pre-approved for financing for purchase of a selected one of the available vehicles; and
providing, to the remote device, a loan offer indicating that the customer is approved for financing to purchase the selected available vehicle.

33. The method of claim 32, the method further comprising receiving a second loan application request, wherein the second loan application request includes a modification of the loan offer.

34. The method of claim 32, the method further comprising transmitting instructions for executing a loan agreement, based on receiving an indication the customer accepted the loan offer.

35. A non-transitory computer readable medium having stored instructions which when executed cause at least one processor to perform a method for providing a loan offer comprising:
receiving, from a remote device, a loan application request, the loan application request comprising a loan term, an identification of a desired vehicle having set of vehicle characteristics, and information identifying a customer;
determining that the customer is not provisionally approved for financing of the desired vehicle;
providing, to the remote device, a loan application response indicating that the customer is not provisionally approved for financing of the desired vehicle;
accessing a merchant inventory database of vehicles available for sale at a merchant location, the database comprising vehicle characteristics for the available vehicles;
obtaining estimated values of the available vehicles from a third party evaluation source;
determining, based on a set of mathematical rules relating to the desired vehicle characteristics, the available vehicle characteristics, the estimated values, and the customer information, that the customer is pre-approved for financing for purchase of a selected one of the available vehicles; and
providing, to the remote device, a loan offer indicating that the customer is approved for financing to purchase the selected available vehicle.

36. A non-transitory computer readable medium of claim 35, the method further comprising receiving a second loan application request, wherein the second loan application request includes a modification of the loan offer.

37. A non-transitory computer readable medium of claim 35, the method further comprising transmitting instructions for executing a loan agreement, based on receiving an indication the customer accepted the loan offer.
